(19) United States
(12) Patent Application Publication
(10) Pub. No.: US 2020/0184418 A1
(43) Pub. Date: Jun. 11, 2020

(54) SYSTEM AND METHOD FOR AUTOMATIC SEQUENCING OF SHIPMENTS

(71) Applicant: NTEX Transportation Services Pvt. Ltd., Pune (IN)

(72) Inventors: Tanay SHAH, Pimpri-Chinchwad (IN); Pushkar OKE, Pimpri-Chinchwad (IN); Vaibhav AGRAWAL, Pimpri-Chinchwad (IN); Yogesh KULKARNI, Pimpri-Chinchwad (IN)

(73) Assignee: NTEX Transportation Services Pvt. Ltd., Pune (IN)

(21) Appl. No.: 16/452,379

(22) Filed: Jun. 25, 2019

(30) Foreign Application Priority Data
Dec. 11, 2018 (IN) 201821046813

(51) Int. Cl. G06Q 10/08; G06Q 10/06; G06N 20/00; G06F 16/29; G08G 1/0968

(52) U.S. Cl. CPC G06Q 10/08355; G06Q 10/06316; G08G 1/096805; G06N 20/00; G06F 16/29; G06Q 10/0833

(57) ABSTRACT

The present disclosure provides a computer-implemented method and system for sequencing of a plurality of shipments in order of delivery. The method includes a first step of receiving a first set of data, a second set of data and a third set of data at sequence determination system. The method includes another step of determining one or more routes with facilitation of the first set of data at the sequence determination system. The method includes yet another step of analyzing the second set of data and the third set of data at the sequence determination system. The method includes yet another step of optimizing a final route form the one or more routes at the sequence determination system. The method includes yet another step of enabling a delivery associate of the one or more delivery associate to edit and approve the final route.

### TECHNICAL FIELD

The present invention relates to the technical field of logistics, and in particular, provides a system and method for automatic sequencing of shipments.

### INTRODUCTION

Over the last few years, there has been a significant rise in e-commerce industry. This rise has in turn led to an increase in demand for logistics along with an increase in demand to deliver shipments in minimum time. Typically, delivery time of shipment depends on various factors. The various factors include drop-off time of the shipments. The drop-off time corresponds to time taken by a delivery associate to deliver the shipments from a delivery warehouse to various customers. The drop-off time includes time taken by the delivery associate to sequence the shipments according to preferred delivery route of the delivery associate. Currently, the shipments are sequenced manually by the delivery associate. However, manual sequencing of the shipments consumes a lot of time. In addition, manual sequencing of the shipments induces errors in sequencing. Moreover, manual sequencing of the shipments is not an optimized sequencing. Also, manual sequencing of the shipments requires skilled delivery associates to deal with it. Efficiency of manual sequencing of the shipments depends on skill set of the delivery associate.

In light of the above stated discussion, there is a need for a method and system which can automate the shipment sequencing process and remove dependencies on delivery associates.

### SUMMARY

In a first example, a computer-implemented method is provided. The computer-implemented method for sequencing of a plurality of shipments in order of delivery. The computer-implemented method includes a first step of receiving a first set of data, a second set of data and a third set of data at a sequence determination system. The first set of data is associated with geographical delivery location of the plurality of shipments. The second set of data is associated with delivery parameters. The third set of data is associated with one or more delivery associates. The computer-implemented method includes another step of determining one or more routes at the sequence determination system with facilitation of the first set of data. The sequence determination system determines the one or more routes with facilitation of positioning system. The computer-implemented method includes yet another step of analyzing the second set of data and the third set of data to enable one or more parameters at the sequence determination system. The computer-implemented method includes yet another step of enabling a delivery associate of the one or more delivery associates to approve and edit the final route. The sequence determination system determines delivery of the plurality of shipments for an efficient delivery. The sequence determination system reduces dependency on the one or more delivery associates for sequencing of the plurality of shipments in the order of delivery.

In an embodiment of the present disclosure, the first set of data is received with facilitation of one or more input devices. The one or more input devices include scanners, optical character readers, bar code readers, cameras and keyboards.

In an embodiment of the present disclosure, the second set of data includes availability of a plurality of customers, preferred slots of the plurality of customers, one or more preferences of the plurality of customers and availability restrictions of the plurality of customers.

In an embodiment of the present disclosure, the sequence determination system receives the third set of data with facilitation of one or more communication devices associated with the one or more delivery associates. The third set of data includes leaving time of the one or more delivery associates, average speed of the one or more delivery associates for delivering each of the plurality of shipments and intervals desired by the one or more delivery associates.

In an embodiment of the present disclosure, the sequence determination system creates profile of each of the one or more delivery associates.

In an embodiment of the present disclosure, the sequence determination system optimizes the final route of the one or more routes with facilitation of the profile of the one or more delivery associates and the one or more parameters.

In an embodiment of the present disclosure, the second set of data and the third set of data are assigned unique priority number to enable the one or more parameters from the second set of data and the third set of data. The one or more parameters are enabled based on the unique priority number.

In an embodiment of the present disclosure, the sequence determination system utilizes past set of data to determine a delivery sequence of the plurality of shipments with facilitation of hardware run machine learning algorithms. The sequence determination system is dynamic and adaptable.

In an embodiment of the present disclosure, the sequence determination system enables the delivery associate of the one or more delivery associates to edit, approve and override the delivery sequence in real time. The delivery associate edits, approves and overrides the delivery sequence with facilitation of the one or more communication devices. The one or more communication devices are connected to the sequence determination system through a communication network. The sequence determination system notifies the plurality of customers with estimated time of delivery of the plurality of shipments.

In an embodiment of the present disclosure, the sequence determination system is associated with a sequencer device. The sequence determination system provides first one or more signals to the sequencer device. The first one or more signals provide instructions for sequencing, loading and unloading of the plurality of shipments. The sequencer device provides second one or more signals to the sequence determination system. The second one or more signals provide real time characteristic status of the sequencer device to the sequence determination system. The sequence determination system provides the first one or more signals and the second one or more signals to the one or more communication devices.

In a second example, a computer system is provided. The computer system includes one or more processors and a memory coupled to the one or more processors. The memory stores instructions. The instructions are executed by the one or more processors. The execution of instruction enables the one or more processors to perform a method for sequencing of a plurality of shipments in order of delivery. The method includes a first step of receiving a first set of data, a second set of data and a third set of data at a sequence determination system. The first set of data is associated with geographical delivery location of the plurality of shipments. The second set of data is associated with delivery parameters. The third set of data is associated with one or more delivery associates. The method includes another step of determining one or more routes at the sequence determination system with facilitation of the first set of data. The sequence determination system determines the one or more routes with facilitation of positioning system. The method includes yet another step of analyzing the second set of data and the third set of data to enable one or more parameters at the sequence determination system. The method includes yet another step of enabling a delivery associate of the one or more delivery associates to approve and edit the final route. The sequence determination system determines delivery of the plurality of shipments for an efficient delivery. The sequence determination system reduces dependency on the one or more delivery associates for sequencing of the plurality of shipments in the order of delivery.

In a third example, a non-transitory computer-readable storage medium is provided. The non-transitory computer-readable storage medium encodes computer executable instructions that, when executed by at least one processor, performs a method for sequencing of a plurality of shipments in order of delivery. The method includes a first step of receiving a first set of data, a second set of data and a third set of data at a sequence determination system. The first set of data is associated with geographical delivery location of the plurality of shipments. The second set of data is associated with delivery parameters. The third set of data is associated with one or more delivery associates. The method includes another step of determining one or more routes at the sequence determination system with facilitation of the first set of data. The sequence determination system determines the one or more routes with facilitation of positioning system. The method includes yet another step of analyzing the second set of data and the third set of data to enable one or more parameters at the sequence determination system. The method includes yet another step of enabling a delivery associate of the one or more delivery associates to approve and edit the final route. The sequence determination system determines delivery of the plurality of shipments for an efficient delivery. The sequence determination system reduces dependency on the one or more delivery associates for sequencing of the plurality of shipments in the order of delivery.

### BRIEF DESCRIPTION OF THE DRAWINGS

Having thus described the invention in general terms, reference will now be made to the accompanying drawings, which are not necessarily drawn to scale, and wherein:

FIG. 1 illustrates an interactive computing environment for sequencing of a plurality of shipments in order of delivery, in accordance with various embodiments of the present disclosure;

FIG. 2 is a flowchart for sequencing of the plurality of shipments in the order of delivery, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

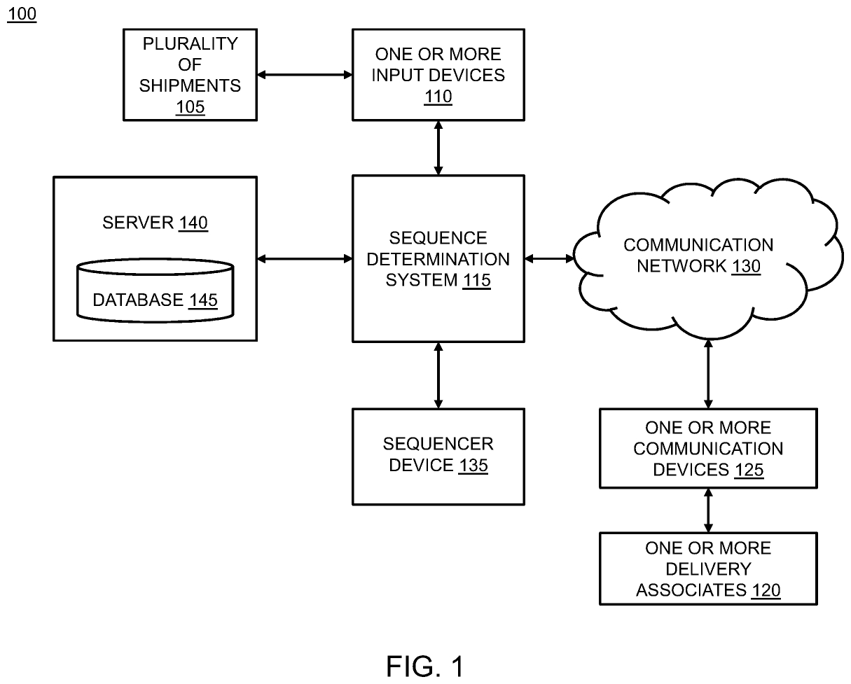

FIG. 1 illustrates an interactive computing environment 100 for sequencing of a plurality of shipments 105 in order of delivery, in accordance with various embodiments of the present disclosure. The interactive computing environment 100 illustrates an environment suitable for an interactive reception and processing of data for determining a delivery sequence for the plurality of shipments 105 for an efficient delivery. In general, the efficient delivery refers to timely and cost-effective delivery of the plurality of shipments 105. The efficient delivery corresponds to less time wasted on unnecessary stoppages and shortest delivery routes. In addition, the efficient delivery corresponds to increased average deliveries, decrease in delivery staff, increased customer satisfaction and the like. The interactive computing environment 100 is configured to provide a setup for sequencing of the plurality of shipments 105 in the order of delivery. The interactive computing environment 100 is configured to enable sequencing of the plurality of shipments 105 in the order of delivery.

The interactive computing environment 100 includes the plurality of shipments 105, one or more input devices 110 and a sequence determination system 115. In addition, the interactive computing environment 100 includes one or more delivery associates 120 associated with one or more communication devices 125. Further, the interactive computing environment 100 includes a communication network 130, a sequencer device 135, a server 140 and a database 145. The above stated elements of the interactive computing environment 100 operate coherently and synchronously to enable sequencing of the plurality of shipments 105 in the order of delivery.

The interactive computing environment 100 includes the plurality of shipments 105. In an embodiment of the present disclosure, the plurality of shipments 105 includes goods and items which are to be delivered to a plurality of customers. In another embodiment of the present disclosure, the plurality of shipments 105 may be devices such as mobile phones, head sets and the like. In yet another embodiment of the present disclosure, the plurality of shipments 105 may be household appliances such as iron, kettle, toaster, and the like. In yet another embodiment of the present disclosure, the plurality of shipments 105 may be any product. The plurality of shipments 105 is associated with the one or more input devices 110.

The interactive computing environment 100 includes the one or more input devices 110. The one or more input devices 110 read or scan a first set of data associated with the plurality of shipments 105. The first set of data includes geographic delivery location of the plurality of shipments 105. The geographic delivery location of the plurality of shipments 105 includes names of locality, house numbers and the like. The one or more input devices 110 includes but may not be limited to scanners, optical character readers, optical mark readers, bar code readers, cameras and keyboards. The one or more input devices 110 are associated with the sequence determination system 115. The one or more input devices 110 provide the first set of data to the sequence determination system 115.

The interactive computing environment 100 includes the one or more delivery associates 120 associated with the one or more communication devices 125. The one or more delivery associates 120 are workers that deliver the plurality of shipments 105 to the plurality of customers. In an embodiment of the present disclosure, the one or more communication devices 125 are hardware devices capable of transmitting data with facilitation of the communication network 130. In an embodiment of the present disclosure, the one or more communication devices 125 includes but may not be limited to smart phone, tablet, laptop and personal digital assistant. The one or more communication devices 125 are connected to the sequence determination system 115 with facilitation of the communication network 130. The communication network 130 provides medium for the one or more communication devices 125 to connect to the sequence determination system 115. Also, the communication network 130 provides network connectivity to the one or more communication devices 125 using a plurality of methods. The plurality of methods are used to provide network connectivity to the one or more communication devices 125 includes 2G, 3G, 4G, Wifi, BLE, LAN, VPN, WAN and the like.

The interactive computing environment 100 includes the sequence determination system 115. The sequence determination system 115 receives the first set of data from the one or more input devices 110. The sequence determination system 115 determines one or more routes based on the first set of data with facilitation of a positioning system. The positioning system acts as navigation satellite to determine the geographical delivery location of the plurality of shipments 105. In an example, the positioning system may be Global Positioning System, Local Positioning System, Global Navigation Satellite System and the like. In addition, the sequence determination system 115 determines the one or more routes based on traffic data. The traffic data is received with the facilitation of the positioning system. Further, the sequence determination system 115 determines the one or more routes from past set of data associated with past deliveries. The past set of data includes pre-defined route map, average delivery speed of each of the one or more delivery associates 120 and the like. In general, pre-defined route map is map of route followed in past deliveries. The sequence determination system 115 determines the past set of data with facilitation of hardware run machine learning algorithms. In an embodiment of the present disclosure, the hardware-run machine learning algorithms include graph-based machine learning algorithms and deep learning algorithms. In addition, the hardware run machine learning algorithms include prediction algorithms, phonetic distance based fuzzy search algorithms and the like. However, the hardware-run machine learning algorithms are not limited to the above mentioned algorithms.

In an embodiment of the present disclosure, the sequence determination system 115 determines the one or more routes by utilizing time based variation in delivery efficiency of a particular location. The sequence determination system 115 utilizes the time based variation in delivery efficiency of the location with facilitation of the past set of data. In an example, the time based variation is the analyzation of time taken to deliver a particular shipment at the particular location based on the past set of data.

The sequence determination system 115 is associated with a computing system. The computing system is associated with the plurality of customers with facilitation of a communication media. The communication media includes but may not be limited to smart phone, laptop, and personal computer. The computing system stores a second set of data received from the plurality of customers at the time of placement of order. The computing system sends the second set of data to the sequence determination system 115. The second set of data is associated with the plurality of customers. In an embodiment of the present disclosure, the second set of data includes availability of the plurality of customers and preferred slots of the plurality of customers. The preferred slots of the plurality of customers may be time frames given by the plurality of customers. In an example, a particular customer X is available from 2 pm to 4 pm and from 7 pm to 9 pm. The time frame of 2 pm to 4 pm and 7 pm to 9 pm will be the preferred slots of the customer X. In addition, the second set of data includes one or more preferences of the plurality of customers, availability restrictions of the plurality of customers and the like. The availability restrictions of the plurality of customers may be the unavailability of the plurality of customers at specified time intervals. In an example, the preferred slot of a customer A is 5 pm to 9 pm, but locality in which the customer A resides, has fixed delivery hours from 8 am to 8 pm. In this case, there is availability restriction of the customer A for 1 hour.

The sequence determination system 115 receives a third set of data associated with the one or more delivery associates 120. The sequence determination system 115 receives the third set of data with facilitation of the one or more communication devices 125. The third set of data includes availability of the one or more delivery associates 120 and leaving time of each of the one or more delivery associates 120. In addition, the third set of data includes intervals desired by the one or more delivery associates 120 and the like. In an embodiment of the present disclosure, the intervals desired by the one or more delivery associates 120 may be lunch breaks, tea breaks, rest and the like.

Further, the sequence determination system 115 creates profile of each of the one or more delivery associates 120. The profile of each of the one or more delivery associates 120 includes past delivery details of each of the one or more delivery associates 120. In addition, the profile of each of the one or more delivery associates 120 includes but may not be limited to one or more preferences of each of the one or more delivery associates 120. The profile of the one or more delivery associates 120 is an important factor for the sequence determination system 115 to determine the delivery sequence.

Furthermore, the sequence determination system 115 analyzes the second set of data and the third set of data. The second set of data and the third set of data are assigned unique priority number and threshold value is set to enable one or more parameters from the second set of data and the third set of data. The one or more parameters are enabled based on the unique priority number. The unique priority number is compared to the threshold value. The one or more parameters are enabled if the unique priority number of the one or more parameters is greater than the threshold value. In an embodiment of the present disclosure, the sequence determination system 115 utilizes the one or more parameters to optimize the final route of the one or more routes. Also, the one or more parameters are necessary factors to determine the delivery sequence. In another embodiment of the present disclosure, the sequence determination system 115 optimizes the final route of the one or more routes with facilitation of route optimization. In general, the route optimization refers to process of determining efficient route of the one or more routes. The route optimization optimizes the final route of the one or more routes based on shortest distance, minimum time and minimum cost.

The sequence determination system 115 enables a delivery associate of the one or more delivery associates 120 to edit, approve and override the delivery sequence. The delivery associate of the one or more delivery associates 120 edits, approves and overrides the delivery sequence with facilitation of knowledge and experience. The delivery associate of the one or more delivery associates 120 may edit, approve and override the delivery sequence using the one or more communication devices 125. In an example, a delivery associate X has observed that the plurality of customers are not available between 1 pm to 2 pm in a locality A. The time duration between 1 pm to 2 pm is time of dispersal of school students. The plurality of customers goes to pick up their children from school during this time duration. However, the delivery time of the shipments fall under this time duration. In this case, the delivery associate X edits or overrides the delivery sequence of shipments. Also, the sequence determination system 115 is adaptable. In an example, a delivery associate Y edits or overrides the delivery sequence. The sequence determination system 115 adapts editing and overriding done by the delivery associate Y of the one or more delivery associates 120 for future use.

The sequence determination system 115 is associated with the sequencer device 135. The sequencer device 135 performs physical sequencing of the plurality of shipments 105 in the order of delivery. In an embodiment of the present disclosure, the order of delivery is reverse order. In an example, a shipment which is unloaded first from the sequencer device 135 is to be delivered in the end. Also, a shipment which is unloaded from the sequencer device 135 at the end is to be delivered first. The sequencer device 135 is associated with one of the one or more input devices 110. Further, the sequence determination system 115 provides first one or more signals to the sequencer device 135. The first one or more signals includes instructions for sequencing of the plurality of shipments 105 in the order of delivery and loading the plurality of shipments 105 into the sequencer device 135. In addition, the first one or more signals include instructions for unloading of the plurality of shipments 105 from the sequencer device 135. The sequencer device 135 performs physical sequencing based on the first one or more signals received by the sequence determination system 115. The sequencer device 135 provides second one or more signals to the sequence determination system 115. The second one or more signals provide real time characteristic status of the sequencer device 135 to the sequence determination system 115. The real time characteristic status includes placement of each of the plurality of shipments 105 in the sequencer device 135 and completion of loading of the plurality of shipments 105. In addition, the real time characteristic status includes error in the placement of the plurality of shipments 105, successful completion of sequencing process, completion of unloading of the plurality of shipments 105 and the like. In an embodiment of the present disclosure, the sequence determination system 115 provides the first one or more signals and the second one or more signals to the one or more communication devices 125. Each of the one or more communication devices 125 are associated with the delivery associate of the one or more delivery associates 120. The delivery associate of the one or more delivery associates 120 get updates regarding the sequencing process in real time with facilitation of the one or more communication devices 125.

In an embodiment of the present disclosure, the sequencer device 135 includes a plurality of sensors. The sequencer device 135 employs the plurality of sensors to monitor loading and unloading of the plurality of shipments 105. The plurality of sensors monitors position of each of the plurality of shipments 105 in the sequencer device 135. The plurality of sensors monitors loading of the plurality of shipments 105. The plurality of sensors monitors unloading of the plurality of shipments 105. The plurality of sensors monitors accurate positioning of each of the plurality of shipments 105 in the sequencer device 135 with respect to loading mechanism to ensure accurate loading. Further, the plurality of sensors monitors accurate positioning of each of the plurality of shipments 105 with respect to unloading mechanism to ensure accurate unloading. The plurality of sensors transfers sensed data to the sequence determination system 115. Each of the plurality of sensors is selected from a group. The group includes infrared sensors, optical sensors, ultrasonic sensors and the like.

The sequence determination system 115 notifies the plurality of customers with estimated time of delivery of the plurality of shipments 105. In an embodiment of the present disclosure, the sequence determination system 115 may send notifications to the plurality of customers through communication methods. The communication methods include emails, short message service and the like. Further, the interactive computing environment 100 includes the server 140 and the database 145. The sequence determination system 115 is associated with the server 140. In general, the server 140 is a computer program or device that provides functionality for other programs or devices. The server 140 provides various functionalities, such as sharing data or resources among a plurality of clients, or performing computation for a client. Furthermore, it may be noted that the server 140 includes the database 145; however, those skilled in the art would appreciate that more number of the server 140 includes more numbers of the databases 145.

In an embodiment of the present disclosure, the sequence determination system 115 is located in the server 140. In another embodiment of the present disclosure, the sequence determination system 115 is connected with the server 140. In yet another embodiment of the present disclosure, the server 140 is a part of the sequence determination system 115. The server 140 handles each operation and task performed by the sequence determination system 115. The server 140 stores one or more instructions for performing the various operations of the sequence determination system 115. The server 140 is associated with an administrator. In general, the administrator manages the different components in the sequence determination system 115. The administrator coordinates the activities of the components involved in the sequence determination system 115. The administrator is any person or individual who monitors the working of the sequence determination system 115 and the server 140 in real time. The administrator monitors the working of the sequence determination system 115 and the server 140 through a computing device. The computing device includes laptop, desktop computer, tablet, personal digital assistant and the like.

The database 145 stores different sets of information associated with various components of the sequence determination system 115. In general, database 145 are used to hold general information and specialized data, such as the first set of data, the second set of data and the third set of data received from the one or more input devices 110. The database 145 organizes the data using models including relational models, hierarchical models and the like.

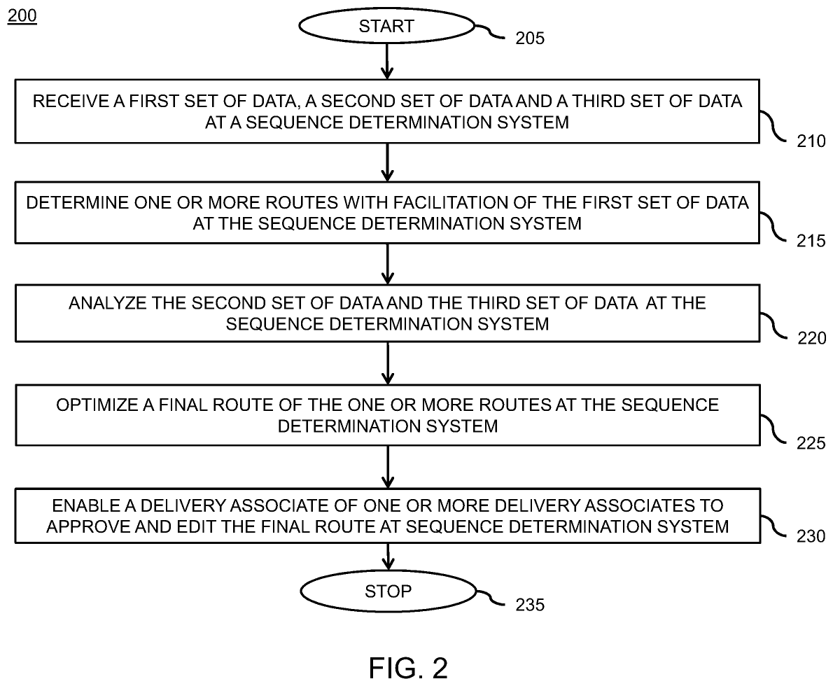

FIG. 2 is a flowchart 200 for sequencing of the plurality of shipments 105 in the order of delivery, in accordance with various embodiments of the present disclosure. The flowchart 200 initiates at step 205. Following step 205, at step 210 the sequence determination system 115 receives the first set of data, the second set of data and the third set of data. At step 215, the sequence determination system 115 determines the one or more routes with facilitation of the first set of data. At step 220, the sequence determination system 115 analyzes the second set of data and the third set of data to enable the one or more parameters. The one or more parameters are significant for adopting the final route from the one or more routes. At step 225, the sequence determination system 115 optimizes the final route from the one or more routes. At step 230, the sequence determination system 115 enables the delivery associate of the one or more delivery associates 120 to approve and edit the final route. The flow chart 200 terminates at step 235.

It may be noted that the flowchart 200 is explained to have above stated process steps; however, those skilled in the art would appreciate that the flowchart 200 may have more/less number of process steps which may enable all the above stated embodiments of the present disclosure.

The sequence determination system 115 may be implemented using a single computing device, or a network of computing devices, including cloud-based computer implementations. The computing devices are preferably server class computers including one or more high-performance computer processors and random access memory, and running an operating system such as LINUX or variants thereof. The operations of the sequence determination system 115 as described herein can be controlled through either hardware or through computer programs installed in non-transitory computer readable storage devices such as solid state drives or magnetic storage devices and executed by the processors to perform the functions described herein. The database 145 is implemented using non-transitory computer readable storage devices, and suitable database management systems for data access and retrieval. The sequence determination system 115 includes other hardware elements necessary for the operations described herein, including network interfaces and protocols, input devices for data entry, and output devices for display, printing, or other presentations of data. Additionally, the operations listed here are necessarily performed at such a frequency and over such a large set of data that they must be performed by a computer in order to be performed in a commercially useful amount of time, and thus cannot be performed in any useful embodiment by mental steps in the human mind.

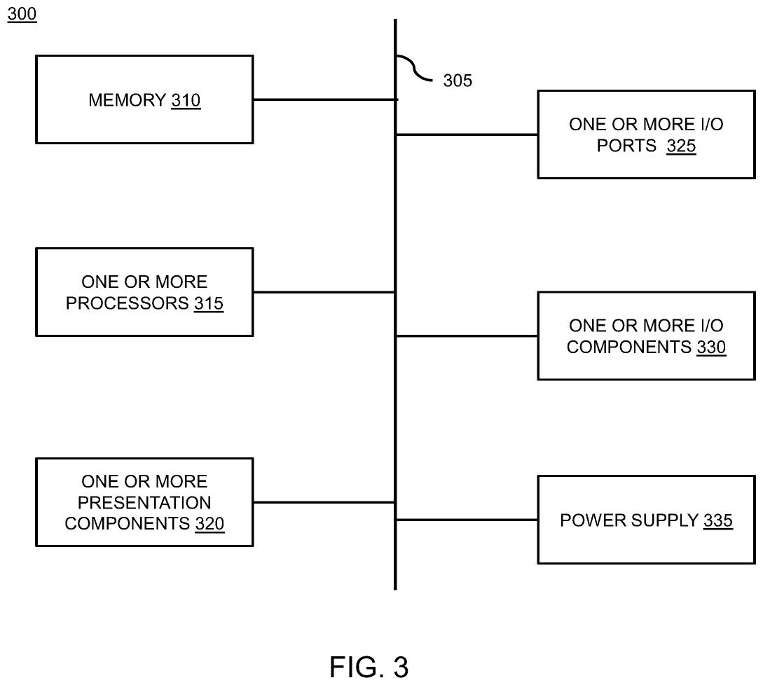

FIG. 3 illustrates a block diagram of the device 300, in accordance with various embodiments of the present disclosure. The device 300 includes a bus 305 that directly or indirectly couples the following devices: memory 310, one or more processors 315, one or more presentation components 320, one or more input/output (I/O) ports 325, one or more input/output components 330, and an illustrative power supply 335. The bus 305 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The device 300 typically includes a variety of computer-readable media. The computer-readable media can be any available media that can be accessed by the device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the device 300. The computer storage media includes, but is not limited to, non-transitory computer readable storage medium that stores program code and/or data for longer periods of time, such as secondary or persistent long term storage, like read only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer-readable media.

Memory 310 includes computer-storage media in the form of volatile and/or nonvolatile memory. The memory 310 may be removable, non-removable, or a combination thereof. Exemplary hardware devices include solid-state memory, hard drives, optical-disc drives, etc. The device 300 includes the one or more processors 315 that read data from various entities such as the memory 310 or I/O components 330. The one or more presentation components 320 present data indications to a user or other device. Exemplary presentation components include a display device, speaker, printing component, vibrating component, etc. The one or more I/O ports 325 allow the device 300 to be logically coupled to other devices including the one or more I/O components 330, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for sequencing of a plurality of shipments in order of delivery, the computer-implemented method comprising:
receiving, at a sequence determination system with a processor, a first set of data, a second set of data and a third set of data, wherein the first set of data is associated with geographical delivery location of the plurality of shipments, wherein the second set of data is associated with a plurality of customers, wherein the third set of data is associated with one or more delivery associates;
determining, at the sequence determination system with the processor, one or more routes with facilitation of the first set of data, wherein the sequence determination system determines the one or more routes with facilitation of positioning system;
analyzing, at the sequence determination system with the processor, the second set of data and the third set of data to enable one or more parameters;
optimizing, at the sequence determination system with the processor, a final route of the one or more routes with facilitation of the one or more parameters; and
enabling, at the sequence determination system with the processor, a delivery associate of the one or more delivery associates to approve and edit the final route,
wherein the sequence determination system with the processor determines a delivery sequence of the plurality of shipments for an efficient delivery, wherein the sequence determination system with the processor reduces dependency on the one or more delivery associates for sequencing of the plurality of shipments in the order of delivery.

2. The computer-implemented method as recited in claim 1, wherein the sequence determination system with the processor receives the third set of data with facilitation of one or more communication devices associated with the one or more delivery associates, wherein the third set of data comprising leaving time of the one or more delivery associates and intervals desired by the one or more delivery associates.

3. The computer-implemented method as recited in claim 1, wherein the sequence determination system with the processor creates profile of each of the one or more delivery associates.

4. The computer-implemented method as recited in claim 1, wherein the sequence determination system with the processor optimizes the final route of the one or more routes with facilitation of the profile of the one or more delivery associates and the one or more parameters.

5. The computer-implemented method as recited in claim 1, wherein the sequence determination system with the processor utilizes past set of data to determine the delivery sequence of the plurality of shipments with facilitation of hardware run machine learning algorithms, wherein the sequence determination system with the processor is adaptable.

6. The computer-implemented method as recited in claim 1, wherein the sequence determination system with the processor enables the delivery associate of the one or more delivery associates to edit, approve and override the delivery sequence in real time, wherein the delivery associate edits, approves and overrides the delivery sequence with facilitation of the one or more communication devices, wherein the one or more communication devices are connected to the sequence determination system with the processor through a communication network, wherein the sequence determination system with the processor notifies the plurality of customers with estimated time of delivery of the plurality of shipments.

7. The computer-implemented method as recited in claim 1, wherein the sequence determination system with the processor is associated with a sequencer device, wherein the sequence determination system with the processor provides first one or more signals to the sequencer device, wherein the first one or more signals provide instructions for sequencing, loading and unloading of the plurality of shipments, wherein the sequencer device provides second one or more signals to the sequence determination system with the processor, wherein the second one or more signals provide real time characteristic status of the sequencer device to the sequence determination system with the processor, wherein the sequence determination system with the processor provides the first one or more signals and the second one or more signals to the one or more communication devices.

8. A computer system comprising:
one or more processors; and
a memory coupled to the one or more processors, the memory for storing instructions which, when executed by the one or more processors, cause the one or more processors to perform a method for sequencing of a plurality of shipments in order of delivery, the method comprising:
receiving, at a sequence determination system, a first set of data, a second set of data and a third set of data, wherein the first set of data is associated with geographical delivery location of the plurality of shipment, wherein the second set of data is associated with a plurality of customers, wherein the third set of data is associated with one or more delivery associates;
determining, at the sequence determination system, one or more routes with facilitation of the first set of data, wherein the sequence determination system determines the one or more routes with facilitation of positioning system;
analyzing, at the sequence determination system, the second set of data and the third set of data to enable one or more parameters;
optimizing, at the sequence determination system, a final route of the one or more routes with facilitation of the one or more parameters; and
enabling, at the sequence determination system, a delivery associate of the one or more delivery associates to approve and edit the final route,
wherein the sequence determination system determines a delivery sequence of the plurality of shipments for an efficient delivery, wherein the sequence determination system reduces dependency on the one or more delivery associates for sequencing of the plurality of shipments in the order of delivery.

9. The computer system as recited in claim 8, wherein the first set of data is received with facilitation of one or more input devices, wherein the one or more input devices comprising scanners, optical character readers, optical mark readers, bar code readers, cameras and keyboards.

10. The computer system as recited in claim 8, wherein the second set of data comprising availability of the plurality of customers, preferred slots of the plurality of customers, one or more preferences of the plurality of customers and availability restrictions of the plurality of customers.

11. The computer system as recited in claim 8, wherein the sequence determination system receives the third set of data with facilitation of one or more communication devices associated with the one or more delivery associates, wherein the third set of data comprising leaving time of the one or more delivery associates and intervals desired by the one or more delivery associates.

12. The computer system as recited in claim 8, wherein the sequence determination system creates profile of each of the one or more delivery associates.

13. The computer system as recited in claim 8, wherein the sequence determination system optimizes the final route of the one or more routes with facilitation of the profile of the one or more delivery associates and the one or more parameters.

14. The computer system as recited in claim 8, wherein the second set of data and the third set of data are assigned unique priority number to enable the one or more parameters from the second set of data and the third set of data, wherein the one or more parameters are enabled based on the unique priority number.

15. The computer system as recited in claim 8, wherein the sequence determination system utilizes past set of data to determine the delivery sequence of the plurality of shipments with facilitation of hardware run machine learning algorithms, wherein the sequence determination system is adaptable.

16. The computer system as recited in claim 8, wherein the sequence determination system enables the delivery associate of the one or more delivery associates to edit, approve and override the delivery sequence in real time, wherein the delivery associate edits, approves and overrides the delivery sequence with facilitation of the one or more communication devices, wherein the one or more communication devices are connected to the sequence determination system through a communication network, wherein the sequence determination system notifies the plurality of customers with estimated time of delivery of the plurality of shipments.

17. The computer system as recited in claim 8, wherein the sequence determination system is associated with a sequencer device, wherein the sequence determination system provides first one or more signals to the sequencer device, wherein the first one or more signals provide instructions for sequencing, loading and unloading of the plurality of shipments, wherein the sequencer device provides second one or more signals to the sequence determination system, wherein the second one or more signals provide real time characteristic status of the sequencer device to the sequence determination system, wherein the sequence determination system provides the first one or more signals and the second one or more signals to the one or more communication devices.

18. A non-transitory computer-readable storage medium encoding computer executable instructions that, when executed by at least one processor, performs a method for sequencing of a plurality of shipments in order of delivery, the method comprising:
receiving, at a computing device associated with a sequence determination system, a first set of data, a second set of data and a third set of data, wherein the first set of data is associated with geographical delivery location of the plurality of shipment, wherein the second set of data is associated with a plurality of customers, wherein the third set of data is associated with one or more delivery associates;
determining, at the computing device associated with the sequence determination system, one or more routes with facilitation of the first set of data, wherein the sequence determination system determines the one or more routes with facilitation of positioning system;
analyzing, at the computing device associated with the sequence determination system, the second set of data and the third set of data to enable one or more parameters;
optimizing, at the computing device associated with the sequence determination system, a final route of the one or more routes with facilitation of the one or more parameters; and
enabling, at the computing device associated with the sequence determination system, a delivery associate of the one or more delivery associates to approve and edit the final route,
wherein the sequence determination system determines a delivery sequence of the plurality of shipments for an efficient delivery, wherein the sequence determination system reduces dependency on the one or more delivery associates for sequencing of the plurality of shipments in the order of delivery.

19. The non-transitory computer-readable storage medium as recited in claim 18, wherein the first set of data is received with facilitation of one or more input devices, wherein the one or more input devices comprising scanners, optical character readers, optical mark readers, bar code readers, cameras and keyboards.

20. The non-transitory computer-readable storage medium as recited in claim 18, wherein the second set of data comprising availability of the plurality of customers, preferred slots of the plurality of customers, one or more preferences of the plurality of customers and availability restrictions of the plurality of customers.
